(19) United States
(12) Patent Application Publication
(10) Pub. No.: US 2004/0160486 A1
(43) Pub. Date: Aug. 19, 2004

(54) Heater apparatus of ink-jet print head and fabrication method thereof

(75) Inventor: Yun-gi Kim, Yogin-city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 10/724,722

(22) Filed: Dec. 2, 2003

(30) Foreign Application Priority Data
Dec. 2, 2002 (KR) 2002-75943
Jan. 14, 2003 (KR) 2003-2536

(51) Int. Cl. B41J 2/05

(52) U.S. Cl. 347/58

(57) ABSTRACT

In a heater apparatus of an ink-jet print head and a fabrication method thereof, heaters and/or wires are formed to have a dopant doped therein by an ion implantation process carried out to regulate a resistance of the heaters and/or the wires, after forming the wire/heater pattern having the heaters and the wires with an electric conductor layer. Alternatively, the heaters and the wires can be formed of a heater pattern and a wire pattern respectively made of a heater layer and a wire layer, instead of forming the wire/resistance heat emitting body pattern with an electric conductor layer.

### CROSS-REFERENCE TO RELATED APPLICATIONS

This application claims the benefit of Korean Application No. 2002-75943, filed Dec. 2, 2002, and Korean Application No. 2003-2536, filed Jan. 14, 2003, both filed in the Korean Intellectual Property Office, the disclosures of which are incorporated herein by reference.

### BACKGROUND OF THE INVENTION

1. Field of the Invention

The present invention relates to a print head of an ink-jet printer and a fabrication method thereof, and more particularly, to a heater apparatus of an ink-jet print head and a fabrication method thereof, having wires and/or heaters of which an electric resistance is regulated by an ion implantation process which is carried out separate from an electric conductor layer forming process, a wire layer and heater layer forming process, or a wire/heater layer forming process.

2. Description of the Related Art

Since an ink-jet printer is excellent in prevention of noise and in obtaining a high resolution and is also capable of performing a color printing at a low cost, consumer demand for ink-jet printers has increased.

Also, with the development of semiconductor technology, fabrication technology of a print head, which is a main component of the ink-jet printer, has been actively developed for the past decade. As a result, a print head having about 300 injection nozzles and capable of providing a resolution of 1200 dpi is being used in a disposable ink cartridge.

FIG. 1 schematically shows a conventional print head 10 for an ink-jet printer.

Generally, ink is supplied from a back surface of a substrate 1 of a print head 10 to a front surface of the substrate 1 through a first ink supply channel 2.

The ink supplied through the first ink supply channel 2 flows along restrictors or second ink supply channels 3 defined by a chamber plate 8 and a nozzle plate 9 to reach ink chambers 4. The ink temporarily stagnating in the ink chambers 4 is instantly boiled by heat generated from heaters 6 disposed under a protective layer 5.

As a result, the ink generates an explosive bubble and, due to the bubble, some of the ink in the ink chambers 4 is discharged outwardly from the print head 10 through nozzles 7 formed above the ink chambers 4.

In such a print head 10, the heaters 6 are important factors that affect an ink flow, an injection pattern of the ink, and an amount of droplets as the ink is discharged, which affects a resolution. Accordingly, materials, shapes and fabrication methods of the heaters 6 have been the subject of considerable research.

A currently used method of fabricating the heaters of the print head is a deposition method, i.e., vapor-depositing material for heaters with a deposition gas on a whole surface of a substrate, and then patterning.

The following descriptions relate to a fabrication process of heaters of a general printer head according to the deposition method.

First, as shown in FIG. 2, there is a silicone substrate 11 which is provided with an oxide layer 12. A TaN layer is vapor-deposited over a whole surface of the silicon substrate to form heaters subsequently in a heater pattern, by a sputtering method of using Ta and N respectively as material for heaters and deposition gas.

At this point, an electric resistance of the heaters is regulated by a thickness of the vapor-deposited TaN layer and an amount of N gas.

Generally, sputtering equipment is set to make an electric resistance of about 53 ohm/sq when a thickness of the TaN layer is about 500 Å. Accordingly, when a print head requires heaters to have an electric resistance of about 30 ohm/sq, the TaN layer is regulated to have a thickness of 850 Å to meet a condition of electric resistance.

Also, to reduce a value of the electric resistance, the amount of N gas can be reduced. However, in this case, a hardness of the TaN layer may be reduced due to increase in an amount of Ta, thereby affecting reliability thereof.

After forming the TaN layer, on the TaN layer is formed a wire layer made of metal such as Al to form wires.

Subsequently, the wire layer is patterned by using a photo resist pattern for wires formed through a photolithography process as an etch mask, so that a wire pattern 14 is formed. The photolithography process to form the photo resist pattern for wires includes forming a photo resist on the wire layer and then patterning the photo resist by using a mask for wires.

Next, the TaN layer is patterned by using a photo resist pattern for heaters formed through a photolithography process as an etch mask, so that the heater pattern 13 is formed. The photolithography process to form the photo resist pattern for heaters includes forming a photo resist on a wire pattern 14 and then patterning the wire pattern by using a mask for heaters.

After forming the heater pattern 13, over a whole surface of the silicon substrate 11 is formed a passivation layer 15 made of silicon nitride, silicon carbide and the like, and then on the passivation layer 15 is vapor-deposited an anti-cavitation layer 16 made of Ta, TaN, TiN and the like.

However, such a conventional fabrication process has a disadvantage that it is difficult to fabricate heaters having required electric resistances due to a limit of the sputtering equipment, and presents a problem that when the electric resistance of the heaters is regulated by the amount of the N gas, the amount of Ta is increased to affect the reliability of the TaN layer.

Also, in the conventional fabrication process, after patterning the TaN layer, the photo resist pattern used as the etch mask is removed. At this point, the photo resist cannot be completely removed, but remains on the TaN layer, thereby resulting in a problem of contaminating the heaters or changing the electric resistance thereof.

### SUMMARY OF THE INVENTION

Accordingly, it is an aspect of the present invention to solve the above problems in the prior art.

It is another aspect of the present invention to provide a heater apparatus of an ink-jet print head and a fabrication method thereof, which can easily fabricate wires and/or heaters having required resistance values and thicknesses, and increase reliability of an electric conductor layer and/or a wire layer and a heater layer forming the wires and/or the heaters. These results are achieved by regulating the electric resistance of the wires and/or the heaters through an ion implantation process and/or a negative ion implantation process which is carried out separate from an electric conductor layer forming process, a wire layer and heater layer forming process, or a wire/heater layer forming process.

It is another aspect of the present invention to provide a heater apparatus of an ink-jet print head and a fabrication method thereof, which can enhance uniformity of a dopant in wires and/or heaters, by performing a heat treatment process after an ion implantation process and/or a negative ion implantation process.

It is still another aspect of the present invention to provide a heater apparatus of an ink-jet print head and a fabrication method thereof, which can form a protective layer (a passivation layer or a capping layer) only on the heaters to increase uniformity of electric resistance thereof, and can reduce a number of fabrication processes, by forming the heaters with an electric conductor layer such as a wire layer, without using a separate heater layer.

It is still another aspect of the present invention is to provide a heater apparatus of an ink-jet print head and a fabrication method thereof, which can prevent contamination of heaters and change in electrical resistance thereof caused by a photo resist used to form a photo resist pattern for heaters, by performing an ion implantation process of using the photo resist pattern for heaters as an ion implantation mask to regulate the electric resistance of the heaters after forming a protective layer (a passivation layer or a capping layer).

Additional aspects and/or advantages of the invention will be set forth in part in the description which follows and, in part, will be obvious from the description, or may be learned by practice of the invention.

The foregoing and/or other aspects may be achieved by providing a heater apparatus of an ink-jet print head including a substrate, a wire/resistance heat emitting body pattern on the substrate and including an electric conductor layer, a plurality of wires in the wire/resistance heat emitting body pattern, a plurality of resistance heat emitting bodies to heat ink in the wire/resistance heat emitting body pattern, and a protective layer formed on the wire/resistance heat emitting body pattern to protect the wire/resistance heat emitting body pattern, wherein the wires have a first dopant doped therein by an ion implantation process carried out to regulate an electric resistance of the wires after forming the wire/resistance heat emitting body pattern over the substrate.

The ion implantation process is carried out by using a photo resist pattern formed on the wire/resistance heat emitting body pattern through a photolithography process to mask the resistance heat emitting bodies, as an ion implantation mask.

The dopant doped during the ion implantation process includes an ionizable dopant such as N₂, B, Ar, P or the like. Also, the electric conductor layer is made of material for heaters such as Ta, Poly-silicon and the like.

Alternatively, the resistance heat emitting bodies can have a dopant doped therein to regulate an electric resistance by an ion implantation process for increasing an electric resistance, i.e., a negative ion implantation process of using the photo resist pattern formed during the ion implantation process for the wires as an ion implantation mask. In this case, the dopant can use an ionizable dopant such as N₂, B, Ar, P or the like, and a negative ion implantation depth, i.e., a negative ion implantation energy is controlled to assure the dopant to reach to the resistance heat emitting bodies disposed under the photo resist pattern. Also, at this point, the electric conductor layer can be made of material for heaters such as Ta, Poly-silicon and the like, or a metal such as Al, Al-contained alloy and the like.

The foregoing and/or other aspects may also be achieved by providing a fabrication method of a heater apparatus of an ink-jet print head including forming an electric conductor layer over a silicon substrate, forming a wire/resistance heat emitting body pattern including a plurality of resistance heat emitting bodies and a plurality of wires by patterning the electric conductor layer, forming a photo resist pattern to mask the resistance heat emitting bodies on the wire/resistance heat emitting body pattern, regulating an electric resistance of the wires of the wire/resistance heat emitting body pattern including performing an ion implantation process using the photo resist pattern as a first ion implantation mask, and removing the photo resist pattern.

In this embodiment, the forming of the electric conductor layer is carried out by using material for heaters such as Ta, poly-silicon and the like, as material for an electric conductor layer.

The forming of the photo resist pattern includes forming a photo resist on the wire/resistance heat emitting body pattern, and performing a light exposure and a developing with respect to the photo resist by a photolithography process of using a mask including a pattern of the resistance heat emitting bodies

The ion implantation process at the regulating of the electric resistance of the wires is carried out by using an ionizable dopant such as N₂, B, Ar, P or the like as a dopant. At this point, the electric resistance of the wires is regulated by type and amount of the dopant used during the ion implantation process.

Also, the removing of the photo resist pattern is carried out by ashing and cleaning processes.

The fabrication method further includes annealing the silicon substrate to increase uniformity of the dopant in the wire/resistance heat emitting body pattern, after the removing of the photo resist pattern. The annealing of the silicon substrate is carried out at a temperature of more than 200° C.

Also, the fabrication method further includes forming a protective layer over the silicon substrate having the wire/resistance heat emitting body pattern formed thereover, after the annealing of the silicon substrate. The forming of the protective layer is carried out by forming a passivation layer over the silicon substrate having the wire/resistance heat emitting body pattern formed thereover, and forming an anti-cavitation layer on the passivation layer.

Alternatively, the fabrication method of the embodiments of the present invention can further include regulating an electric resistance of the resistance heat emitting bodies of the wire/resistance heat emitting body pattern by performing a negative ion implantation process of using the photo resist pattern to mask the resistance heat emitting bodies as an ion implantation mask.

In this case, the negative ion implantation process at the regulating of the electric resistance of the resistance heat emitting bodies is carried out by using an ionizable dopant such as N₂, B, Ar, P or the like as a dopant, and controlling an ion implantation energy to assure the dopant to reach to the resistance heat emitting bodies disposed under the photo resist pattern. At this point, the electric resistance of the resistance heat emitting bodies is regulated by type and amount of the dopant used during the negative ion implantation process. Also, at this point, the forming of the electric conductor layer is carried out by using material for heaters such as Ta, Poly-silicon and the like, or a metal such as Al, Al-contained alloy and the like, as material for an electric conductor layer.

The foregoing and/or other aspects may also be achieved by providing a heater apparatus of an ink-jet print head including a substrate, a wire/resistance heat emitting body pattern on the substrate and including an electric conductor layer, a plurality of wires in the wire/resistance heat emitting body pattern, a plurality of resistance heat emitting bodies to heat ink in the wire/resistance heat emitting body pattern, and a protective layer formed on the wire/resistance heat emitting body pattern to protect the wire/resistance heat emitting body pattern, wherein the resistance heat emitting bodies have a dopant doped therein by an ion implantation process carried out to regulate an electric resistance of the resistance heat emitting bodies after forming the wire/resistance heat emitting body pattern over the substrate.

The ion implantation process is carried out by using a photo resist pattern formed on the wire/resistance heat emitting body pattern through a photolithography process to open the resistance heat emitting bodies, as an ion implantation mask.

The dopant doped during the ion implantation process includes an ionizable dopant such as N₂, B, Ar, P and the like.

Also, the electric conductor layer is made of a metal such as Al, Al-contained alloy and the like.

The foregoing and/or other aspects may also be achieved by providing a fabrication method of a heater apparatus of an ink-jet print head including forming an electric conductor layer over a silicon substrate, forming a wire/resistance heat emitting body pattern including a plurality of resistance heat emitting bodies and a plurality of wires by patterning the electric conductor layer, forming a photo resist pattern to open the resistance heat emitting bodies on the wire/resistance heat emitting body pattern, regulating an electric resistance of the resistance heat emitting bodies of the wire/resistance heat emitting body pattern including performing an ion implantation process using the photo resist pattern as an ion implantation mask, and removing the photo resist pattern.

The forming of the electric conductor layer is carried out by using a metal such as Al, Al-contained alloy and the like, as material for an electric conductor layer.

The forming of the photo resist pattern includes forming a photo resist on the wire/resistance heat emitting body pattern, and performing a light exposure and a developing with respect to the photo resist by a photolithography process of using a mask including a pattern of the wires.

The ion implantation process of the regulating the of the electric resistance of the resistance heat emitting bodies is carried out by using an ionizable dopant such as N₂, B, Ar, P or the like as a dopant. At this point, the electric resistance of the resistance heat emitting bodies is regulated by kind and amount of the dopant used during the ion implantation process.

Also, the removing of the photo resist pattern is carried out by ashing and cleaning processes.

The fabrication method further includes annealing the silicon substrate to increase a uniformity of the dopant in the wire/resistance heat emitting body pattern, after removing of the photo resist pattern. The annealing of the silicon substrate is carried out at a temperature of more than 200° C.

Also, the fabrication method of the embodiment of the present invention further includes forming of a protective layer over the silicon substrate having the wire/resistance heat emitting body pattern formed thereover, after the annealing of the silicon substrate. The forming of the protective layer is carried out by forming a passivation layer over the silicon substrate having the wire/resistance heat emitting body pattern formed thereover, and forming an anti-cavitation layer on the passivation layer.

The foregoing and/or other aspects may also be achieved by providing a heater apparatus of an ink-jet print head including a substrate, a resistance heat emitting body pattern formed over the substrate and including a plurality of resistance heat emitting bodies to heat ink, a wire pattern formed on the resistance heat emitting body pattern and having a plurality of wires, and a protective layer formed on the resistance heat emitting body pattern and the wire pattern to protect the resistance heat emitting body pattern and the wire pattern, wherein the resistance heat emitting bodies have a dopant doped therein by an ion implantation process carried out to regulate an electric resistance of the resistance heat emitting bodies after forming the resistance heat emitting body pattern and the wire pattern over the substrate.

The wires are formed to not have the dopant doped therein by using a photo resist pattern formed through a photolithography process as an ion implantation mask to mask the wires, during the ion implantation process for the resistance heat emitting bodies.

The dopant includes an ionizable dopant such as N₂, B, Ar, P or the like.

Alternatively, the wires can be formed to have the dopant doped during the ion implantation process for the resistance heat emitting bodies. In this case, a sum total in thickness of the resistance heat emitting body pattern and the wire pattern is 500 Å, and the thickness of the wire pattern is thick enough to assure the dopant doped during the ion implantation process to not affect an electric resistance of the wires. Furthermore, the thickness of the resistance heat emitting body pattern is thin enough to assure the dopant doped during the ion implantation process regulates the electric resistance of the resistance heat emitting bodies. Also, the dopant includes an ionizable dopant such as N₂, B, Ar, P or the like.

The resistance heat emitting body pattern is made of material for heaters such as Ta, poly-silicon and the like, and the wire pattern is made of a metal such as Al, Al-contained alloy and the like.

The foregoing and/or other aspects may also be achieved by providing a fabrication method of a heater apparatus of an ink-jet print head including forming a resistance heat emitting body layer over a silicon substrate, forming a wire layer on the resistance heat emitting body layer, forming a wire pattern by patterning the wire layer, forming a resistance heat emitting body pattern by patterning the resistance heat emitting body layer, and doping the resistance heat emitting body pattern including a plurality of heat emitting bodies over the silicon substrate over which the resistance heat emitting body pattern and the wire pattern are formed.

The forming of the resistance heat emitting body layer is carried out by using material for heaters such as Ta, poly-silicon and the like as material for the resistance heat emitting body layer, and the forming of the wire layer is carried out by using a metal such as Al, Al-contained alloy and the like as material for the wire layer.

The doping of the resistance heat emitting body pattern includes forming a photo resist over the silicon substrate over which the wire pattern and the resistance heat emitting body pattern are formed, forming a photo resist pattern for opening the resistance heat emitting bodies by exposing the photo resist to light and then developing the exposed photo resist through a photolithography process, performing an ion implantation process by using the photo resist pattern as an ion implantation mask, and removing the photo resist pattern. The performing of the ion implantation process is carried out by using an ionizable dopant such as N₂, B, Ar, P. Also, removing of the photo resist pattern is carried out by ashing and cleaning processes.

Alternatively, the doping of the resistance heat emitting body pattern can be carried out by performing an ion implantation process without using an ion implantation mask to allow a dopant to be doped into the wire pattern. At this point, the ion implantation process is carried out by using an ionizable dopant such as N₂, B, Ar, P or the like as a dopant.

The fabrication method further includes annealing the silicon substrate to increase uniformity of a dopant in the resistance heat emitting body pattern, after the doping of the resistance heat emitting body pattern. The annealing of the silicon substrate is carried out at a temperature of more than 200° C.

The foregoing and/or other aspects may also be achieved by providing a heater apparatus of an ink-jet print head including a substrate, a resistance heat emitting body pattern formed over the substrate and including a plurality of resistance heat emitting bodies to heat ink, a plurality of switching elements, a wire pattern formed on the resistance heat emitting body pattern and including a plurality of wires connecting the switching elements; and a protective layer formed on the resistance heat emitting body pattern and the wire pattern to protect the resistance heat emitting body pattern and the wire pattern, wherein the resistance heat emitting bodies have a dopant doped therein by an ion implantation process carried out to regulate an electric resistance of the resistance heat emitting bodies after forming the protective layer on the resistance heat emitting body pattern and the wire pattern.

The wires are formed not to have the dopant doped therein by using a photo resist pattern formed through a photolithography process as an ion implantation mask to mask the wires during the ion implantation process for the resistance heat emitting bodies.

The dopant includes an ionizable dopant such as N₂, B, Ar, P or the like.

Alternatively, the wires can be formed to have the dopant doped therein during the ion implantation process for the resistance heat emitting bodies. In this case, a sum total in thickness of the resistance heat emitting body pattern and the wire pattern is 500 Å, and the wire pattern is thick enough to assure that the dopant doped during the ion implantation process does not affect an electric resistance of the wires. The resistance heat emitting body pattern is thin enough to assure that the dopant doped during the ion implantation process regulates the electric resistance of the resistance heat emitting bodies. Also, the dopant includes an ionizable dopant such as N₂, B, Ar, P or the like.

The foregoing and/or other aspects may also be achieved by providing a heater apparatus of an ink-jet print head including a substrate, a plurality of switching elements, a wire/resistance heat emitting body pattern formed of an electric conductor layer over the substrate and having a plurality of resistance heat emitting bodies to heat ink and a plurality of wires connecting the switching elements, and a protective layer formed on the wire/resistance heat emitting body pattern to protect the wire/resistance heat emitting body pattern, wherein the resistance heat emitting bodies have a dopant doped therein by an ion implantation process carried out by using a photo resist pattern formed through a photolithography process as an ion implantation mask to regulate an electric resistance of the resistance heat emitting bodies.

The wires are formed not to have the dopant doped therein by being masked through the photo resist pattern used as the ion implantation mask during the ion implantation process for the resistance heat emitting bodies.

The dopant includes an ionizable dopant such as N₂, B, Ar, P or the like.

The foregoing and/or other aspects may also be achieved by providing a fabrication method of a heater apparatus of an ink-jet print head including forming a resistance heat emitting body layer including a plurality of resistance heat emitting bodies over a silicon substrate, forming a wire layer on the resistance heat emitting body layer, forming a wire pattern by patterning the wire layer, forming a resistance heat emitting body pattern by patterning the resistance heat emitting body layer, forming a protective layer over a whole surface of the silicon substrate over which the resistance heat emitting body pattern is formed, and doping the resistance heat emitting body pattern over the silicon substrate.

The doping of the resistance heat emitting body pattern includes forming a photo resist on the protective layer, forming a photo resist pattern for opening the resistance heat emitting bodies by exposing the photo resist to light and then developing the exposed photo resist through a photolithography process, performing an ion implantation process by using the photo resist pattern as an ion implantation mask, and removing the photo resist pattern. The performing of the ion implantation process is carried out by using an ionizable dopant such as N₂, B, Ar, P or the like as a dopant. Also, the removing of the photo resist pattern is carried out by an ashing and cleaning process.

Alternatively, the doping of the resistance heat emitting body pattern can include performing an ion implantation process without using an ion implantation mask to allow a dopant to be doped into the wire pattern. At this point, the ion implantation process is carried out by using an ionizable dopant such as N₂, B, Ar, P or the like as the dopant.

The fabrication method includes annealing the silicon substrate to increase uniformity of a dopant in the resistance heat emitting body pattern, after the doping of the resistance heat emitting body pattern. The annealing of the silicon substrate may be carried out at a temperature of more than 200° C.

The foregoing and/or other aspects may also be achieved by providing a fabrication method of a heater apparatus of an ink-jet print head including forming an electric conductor layer over a silicon substrate, forming a wire/resistance heat emitting body pattern including a plurality of wire/resistance heat emitting bodies by patterning the electric conductor layer, forming a protective layer over the silicon substrate over which the wire/resistance heat emitting body pattern is formed, forming a photo resist pattern to open the wire/resistance heat emitting bodies on the protective layer, forming the wire/resistance heat emitting bodies in the wire/resistance heat emitting body pattern including performing an ion implantation process using the photo resist pattern as an ion implantation mask, and removing the photo resist pattern.

The forming of the photo resist pattern includes forming a photo resist on the protective layer, and exposing the photo resist to light and then developing the exposed photo resist through a photolithography process of using a mask including a pattern of the resistance heat emitting bodies.

The ion implantation process of the forming of the wire/resistance heat emitting bodies is carried out by using an ionizable dopant such as N₂, B, Ar, P or the like as a dopant.

Also, the removing of the photo resist pattern is carried out by ashing and cleaning.

The fabrication method may further include annealing of the silicon substrate to increase uniformity of a dopant in the resistance heat emitting bodies, after the removing of the photo resist pattern. The annealing of the silicon substrate is carried out at a temperature of more than 200° C.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cross sectional view showing a general print head;

FIG. 2 is a cross sectional view showing a heater apparatus of a conventional ink-jet print head;

FIGS. 3A to 3C are views showing a process of fabricating a heater apparatus of an ink-jet print head according a first embodiment of the present invention;

FIGS. 4A to 4D are views showing a process of fabricating a heater apparatus of an ink-jet print head according a second embodiment of the present invention;

FIGS. 5A to 5C are views showing a process of fabricating a heater apparatus of an ink-jet print head according a third embodiment of the present invention;

FIGS. 6A to 6C are views showing a process of fabricating a heater apparatus of an ink-jet print head according a fourth embodiment of the present invention;

FIGS. 7A to 7C are views showing a process of fabricating a heater apparatus of an ink-jet print head according a fifth embodiment of the present invention; and

FIGS. 8A to 8C are views showing a process of fabricating a heater apparatus of an ink-jet print head according a sixth embodiment of the present invention.

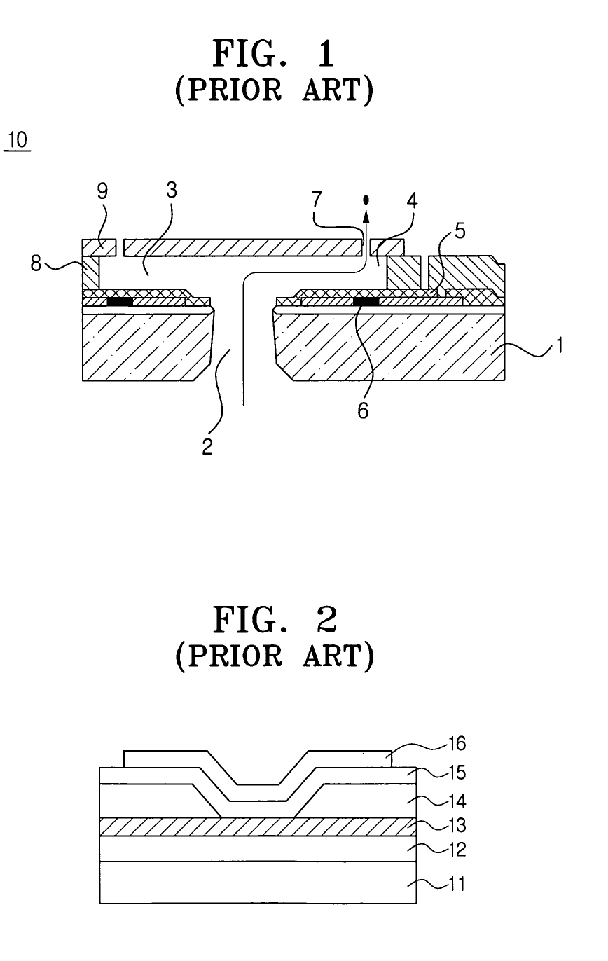

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

Embodiment 1

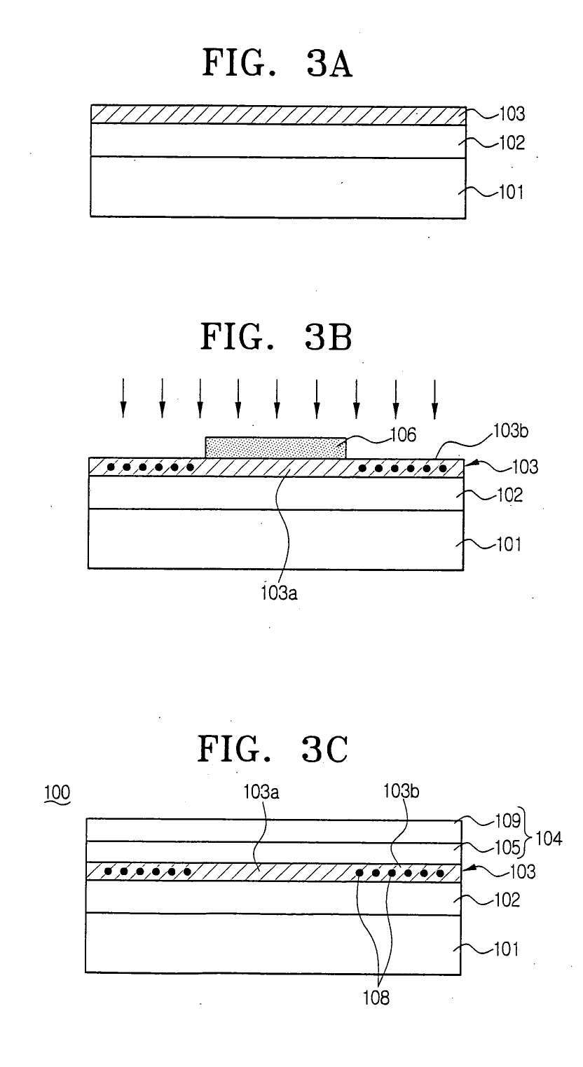

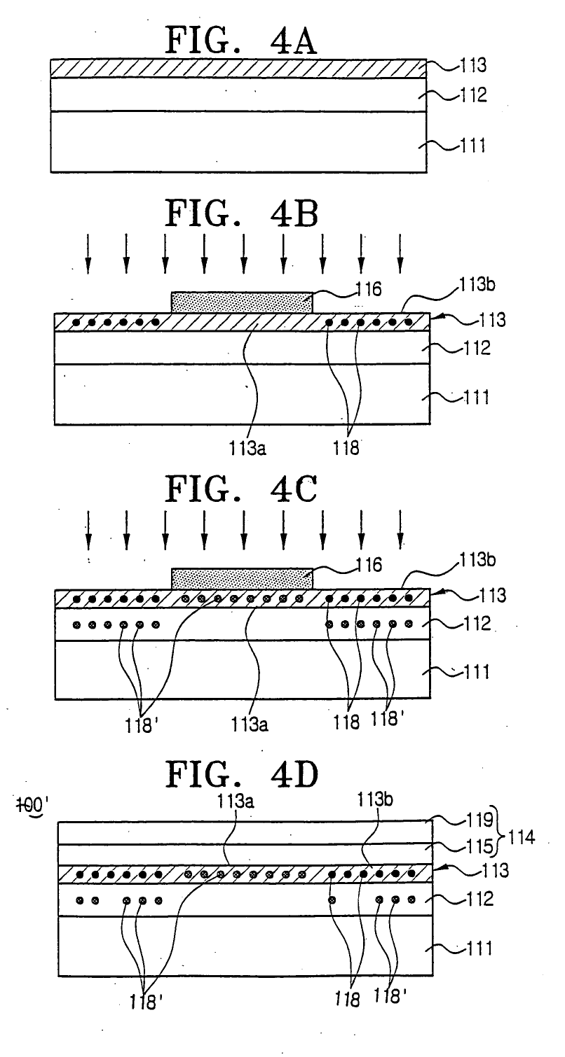

FIG. 3C shows a heater apparatus 100 of an ink-jet print head, having heaters 103a and wires 103b according to a first embodiment of the present invention.

The heater apparatus 100 of this embodiment includes a semiconductor substrate 101 such as a silicon substrate, and a wire/heater pattern 103 formed of one electric conductor layer over the silicon substrate 101 having a plurality of the heaters 103a. The heaters 103a may be resistance heat emitting bodies to heat ink. The heater apparatus 100 further includes a plurality of the wires 103b to connect switching elements such as a source, drain and gate of transistor, and a protective layer 104 formed on the wire/heater pattern 103 to protect the wire/heater pattern 103.

On the silicon substrate 101 is disposed an insulator layer 102 as an interlayer dielectric layer. The insulator layer 102 is formed of oxide on a whole surface of the silicon substrate 101.

The wire/heater pattern 103 disposed on the insulator layer 102 is formed by vapor-depositing an electric conductor layer made of material for heaters such as Ta, poly-silicon or the like on the insulator layer 102 by a sputtering method or the like. Then, patterning of the electric conductor layer by using a photo resist pattern (not shown) for wires/heaters formed by a photolithography process as an etch mask.

The wires 103b formed in the wire/heater pattern 103 have a dopant 108 doped therein by an ion implantation process after forming the wire/heater pattern 103 on the insulator layer 102. The ion implantation process uses a photo resist pattern 106 to mask heaters to be formed, formed on the wire/heater pattern 103 through a photolithography process, as an ion implantation mask, as shown in FIG. 3B.

The dopant 108, which may be one of any kind of ionizable dopants including N₂, B, Ar, P and the like, functions to regulate an electric resistance of the wires 103b at a required value. For example, this value may be a value lower than that of an electric resistance of the electric conductor layer made of the material for heaters forming the heaters 103a of the wire/heater pattern 103.

During the ion implantation process, as the heaters 103a are masked by the photo resist pattern 106 formed through the photolithography process, the dopant 108 is not implanted in the heaters 103a, but in the photo resist pattern 106. Accordingly, the heaters 103a are formed only of the electric conductor layer made of the material for heaters, of which an electric resistance is not regulated during the ion implantation process.

The protective layer 104 includes a passivation layer 105 and an anti-cavitation layer 109. The passivation layer 105 is made of silicon nitride, silicon carbide or the like, which can not only act as a passivation layer, but also act as a capping layer for the heaters 103a and wires 103b. The anti-cavitation layer 109 is made of a metal layer such Ta, TaN, TiN or the like and vapor-deposited on the passivation layer 105 to isolate ink.

A fabrication method of the heater apparatus 100 of the ink-jet print head as constructed according to the first embodiment of the present invention will be described in great detail with reference to FIGS. 3A through 3C.

First, there is provided a silicon substrate 101 having the insulator layer 102 formed thereon.

Next, over a whole surface of the silicon substrate 101 having the insulator layer 102 formed thereon is vapor-deposited an electric conductor layer made of material for heaters such as Ta, poly-silicon or the like by a sputtering process or a low pressure chemical vapor deposition (LPVCD) process.

And then, the electric conductor layer is patterned by using a photo resist pattern (not shown) for wires/heaters formed through a photolithography process as an etch mask, so that a wire/heater pattern 103 is formed, as shown in FIG. 3A. At this point, the photolithography process to form the photo resist pattern for wires/heaters is carried out by forming a photo resist on the electric conductor layer, and then exposing the photo resist to light by using a photo mask for wires/heaters (not shown) and developing the exposed photo resist.

Subsequently, over the substrate 101 having the wire/heater pattern 103 formed thereover, a photo resist (not shown) is formed. Then, as shown in FIG. 3B, a photo resist pattern 106 to mask heaters to be formed later is formed by performing a light exposure and a developing with respect to the photo resist through a photolithography process of using a photo mask for heaters.

After that, an ion implantation process is carried out with respect to the wire/heater pattern 103 by using the photo resist pattern 106 as an ion implantation mask, so that in the wire/heater pattern 103, heaters 103a and wires 103b are formed. At this time, in the wires 103b, the dopant 108 is implanted, but in the heaters 103a, the dopant 108 is not implanted since it is implanted in the photo resist pattern 106 and masked thereby. Accordingly, an electric resistance of the heaters 103a in which the dopant 108 is not implanted is not changed, whereas an electric resistance of the wires 103b in which the dopant 108 is implanted is changed.

During the ion implantation process, the dopant 108 can use any type of ionizable dopant such as N₂, B, Ar, P or the like. The electric resistance of the wires 103b is regulated by type and amount of the dopant 108 used during the ion implantation process.

After regulating the electric resistance of the wires 103b by the ion implantation process, the photo resist pattern 106 in which the dopant 108 is implanted is removed by ashing and cleaning processes.

The ashing process includes a dry ashing, i.e., removing one part of the photo resist pattern 106 while injecting oxygen gas ranging from 3,000 to 5,000 standard cubic centimeter per minute (SCCM) at an atmosphere of vacuum ranging from 0.8 to 1.2 Torr, and the cleaning process includes removing the other part of the photo resist pattern 106 by using H₂SO₄ or a mixed gas in which CF₄ gas and oxygen gas are mixed at a certain rate, after removing the one part of the photo resist pattern 106 through the dry ashing.

Thus, after removing the photo resist pattern 106, the silicon substrate 101 having the heater 103a and wires 103b formed thereover is annealed at a temperature of more than 200° C. to increase uniformity of the dopant 108 in the wires 103b of the wire/heater pattern 103.

After annealing the resultant substrate 101, as shown in FIG. 3C, over a whole surface of the resultant substrate 101 is formed a passivation layer 105 such as a silicon nitride, silicon carbide and the like that acts as a capping layer of the heater 103a and the wires 103b.

After that, on the passivation layer 105 is vapor-deposited an anti-cavitation layer 109 made of a metal layer such as Ta, TaN, TiN and the like, and the fabrication of the heater apparatus 100 of the ink-jet print head is finally completed.

Embodiment 2

FIG. 4D shows a heater apparatus 100′ of an ink-jet print head, having heaters 113a and wires 113b according to a second embodiment of the present invention.

Similar to the heater apparatus 100 of the first embodiment explained with reference to FIGS. 3A through 3C, the heater apparatus 100′ of this embodiment includes a semiconductor substrate 111 such as a silicon substrate, and a wire/heater pattern 113 formed of one electric conductor layer over the silicon substrate 111 and having a plurality of the heaters 113a. The heaters 113a may be resistance heat emitting bodies to heat ink. The heater apparatus 108 further includes a plurality of wires 113b, and a protective layer 114 formed on the wire/heater pattern 113 to protect the wire/heater pattern 113.

On the silicon substrate 111 is disposed an insulator layer 112 as an interlayer dielectric layer. The insulator layer 112 is formed of oxide on a whole surface of the silicon substrate 111.

The wire/heater pattern 113 disposed on the insulator layer 112 is formed by vapor-depositing an electric conductor layer made of material for heaters such as Ta, poly-silicon or the like, or sputtering a metal such as Al, Al-contained alloy or the like on the insulator layer 112 Then, the electric conductor layer is patterned by using a photo resist pattern (not shown) for wires/heaters formed by a photolithography process.

The wires 113b formed in the wire/heater pattern 113 have a dopant 118 doped therein by an ion implantation process after forming the wire/heater pattern 113 on the insulator layer 112. The ion implantation process uses a photo resist pattern 116 to mask heaters to be formed later, formed on the wire/heater pattern 113 through a photolithography process, as an ion implantation mask, as shown in FIG. 4B

Such a dopant 118, which includes an ionizable dopant such as N₂, B, Ar, P or the like, functions to regulate an electric resistance of the wires 113b at a required value. For example, a value lower than an electric resistance of the electric conductor layer made of the material for heaters or the metal forming the heaters 113a of the wire/heater pattern 113.

The heaters 113a of the wire/heater pattern 113 are formed by an ion implantation for increasing an electric resistance, i.e., a negative ion implantation of using the photo resist pattern 116 formed by the photolithography process during the ion implantation process for the wires 113b as an ion implantation mask.

During the negative ion implantation, another dopant 118′ can be one of any ionizable dopant such as N₂, B, Ar, P or the like. The dopant 118′ regulates an electric resistance of the heaters 113a at a required value, i.e., a value higher than that of an electric resistance of the wires 113b.

As in the heater apparatus 100 of the first embodiment, the protective layer 114 includes a passivation layer 115 made of silicon nitride, silicon carbide or the like, and an anti-cavitation layer 119 made of a metal layer such Ta, TaN, TiN and the like vapor-deposited on the passivation layer 115.

A fabrication method of the heater apparatus 100′ of the ink-jet print head as constructed according to the second embodiment of the present invention will be described in great detail with reference to FIGS. 4A through 4D.

First, as shown in FIGS. 4A and 4B, the insulator layer 112, the wire/heater pattern 113, the photo resist pattern 116 to mask heaters, and the wires 113b are formed in turn over the silicon substrate 111, in the same manner as in the heater apparatus 100 of the first embodiment explained with reference to FIGS. 3A and 3B.

At this time, an electric conductor layer forming the wire/heater pattern 113 is formed of material for heaters such as Ta, poly-silicon and the like, or a metal such as Al, Al-contained alloy and the like, which has good conductivity to form heaters and wires and is able to be easily patterned, by a sputtering process or a LPVCD process.

And then, as shown in FIG. 4C, to increase an electric resistance of the heaters 113a, a negative ion implantation process is carried out with respect to the silicon substrate 111 having the wires 113b formed thereover. At this point, the wires 113b have an electric resistance regulated by a dopant 118 implanted therein through an ion implantation process for wires.

In the negative ion implantation process, the photo resist pattern 116 is used as an ion implantation mask, and one of N₂, B, Ar, P and the like is used as the dopant 118′.

The type and amount of the dopant 108 used during the negative ion implantation process are properly selected and regulated to meet a required value of the electric resistance of the heaters 113a.

Also, a negative ion implantation depth, i.e., a negative ion implantation energy, is controlled such that the dopant 118′ is implanted in the wire/heater pattern 113 through the photo resist pattern 116 over a part of the silicon substrate 111 over which the photo resist pattern 116 is formed. The dopant 118′ is also implanted in the insulator 112 through the wire/heater pattern 113 over a part of the silicon substrate 111 over which the photo resist pattern 116 is not formed.

At this point, since the insulator layer 112 is formed of oxide having a high insulating property, the dopant 118′ almost never affects electric resistance of the insulator layer 112, and thereby the insulator layer 112 still functions as an insulator even though the electric conduction layer is patterned thereon.

After regulating the electric resistance of the heaters 113a in the wire/heater pattern 113 through the negative ion implantation process, the photo resist pattern 116 is removed by ashing and cleaning processes. Then, the resultant substrate 111 is annealed at a temperature of more than 200° C. to increase uniformity of the dopants 118 and 118′ in the heaters 113a and the wires 113b of the wire/heater pattern 113, as in the heater apparatus 100 of the first embodiment.

After annealing the resultant substrate 111, as shown in FIG. 4D, over a whole surface of the resultant substrate 111 are formed in turn a passivation layer 115 such as silicon nitride, silicon carbide or the like and the anti-cavitation layer 119 made of a metal layer such as Ta, TaN, TiN or the like. The fabrication of the heater apparatus 100′ of the ink-jet print head is finally completed.

Embodiment 3

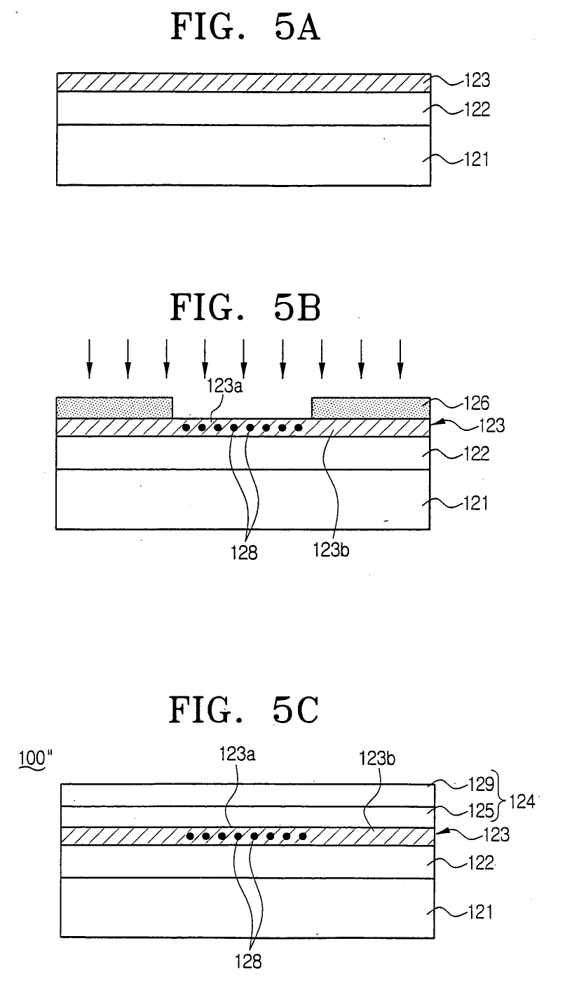

FIG. 5C shows a heater apparatus 100″ of an ink-jet print head, having heaters 123a and wires 123b according to a third preferred embodiment of the present invention.

The heater apparatus 100″ of this embodiment includes a semiconductor substrate 121 such as a silicon substrate, and a wire/heater pattern 123 formed of one electric conductor layer over the silicon substrate 121 and having a plurality of the heaters 123a. The heaters 123a may be resistance heat emitting bodies to heat ink. The heater apparatus further includes a plurality of wires 123b, and a protective layer 124 formed on the wire/heater pattern 123 to protect the wire/heater pattern 123.

On the silicon substrate 121 is disposed an insulator layer 122 as an interlayer dielectric layer. The insulator layer 122 is formed of oxide on a whole surface of the silicon substrate 121.

The wire/heater pattern 123 disposed on the insulator layer 122 is formed by vapor-depositing an electric conductor layer on the insulator layer 122 by a sputtering method and the like, and then patterning the electric conductor layer by using a photo resist pattern (not shown) for wires/heaters formed by a photolithography process as an etch mask. The electric conductor layer is made of a metal such as Al, Al-contained alloy and the like, which is able to be easily patterned and to form wires.

The heaters 123a formed in the wire/heater pattern 123 have a dopant 128 doped therein by an ion implantation process after forming the wire/heater pattern 123 on the insulator layer 122. The ion implantation process uses a photo resist pattern 126 to open heaters 123a to be formed later, formed on the wire/heater pattern 123 through a photolithography process, as an ion implantation mask, as shown in FIG. 5B.

Such a dopant 128, which includes one of any type of ionizable dopants including N₂, B, Ar, P and the like, regulates an electric resistance of the heaters 123a at a required value. For example, a value higher than an electric resistance of the electric conductor layer forming the wires 123b of the wire/heater pattern 123.

During the ion implantation process, as the wires 123b of the wire/heater pattern 123 are masked by the photo resist pattern 126 formed through the photolithography process, the dopant 128 is not implanted in the wires 123b, but in the photo resist pattern 126. Accordingly, the wires 123b are formed only of the electric conductor layer, in which an electric resistance is not regulated during the ion implantation process.

The protective layer 124 includes a passivation layer 125 made of silicon nitride, silicon carbide and the like. The passivation layer 125 can not only act as a passivation layer, but also as a capping layer for the heater 123a and the wires 123b. The protective layer 124 also includes an anti-cavitation layer 129 made of a metal layer such Ta, TaN, TiN or the like vapor-deposited on the passivation layer 125 to isolate ink.

A fabrication method of the heater apparatus 100″ of the ink-jet print head as constructed according to the third embodiment of the present invention will be described in great detail with reference to FIGS. 5A through 5C.

First, as shown in FIG. 5A, the insulator layer 122 and the wire/heater pattern 123 are formed in turn on the silicon substrate 121, in the same manner as the heater apparatus 100 of the first embodiment.

At this time, an electric conductor layer forming the wire/heater pattern 123 is formed of a metal such as Al, Al-contained alloy or the like, which has good conductivity to form heaters and wires and is able to be easily patterned.

Next, a photo resist (not shown) is formed on the substrate 121 having the wire/heater pattern 123 formed thereover, and then (as shown in FIG. 5B), a photo resist pattern 126 to open heaters to be formed later is formed by performing a light exposure and a developing with respect to the photo resist through a photolithography process of using a photo mask for heaters.

Next, an ion implantation process is carried out with respect to the wire/heater pattern 123 by using the photo resist pattern 126 as an ion implantation mask, so that in the wire/heater pattern 123, heaters 123a and wires 123b are formed. At this time, in the heaters 123a, the dopant 128 is implanted, but in the wires 123b, the dopant 128 is not implanted since it is implanted in the photo resist pattern 126 and masked thereby. Accordingly, an electric resistance of the heaters 123a in which the dopant 128 is implanted is changed, whereas an electric resistance of the wires 123b in which the dopant 128 is not implanted is not changed.

During the ion implantation process, the dopant 128 uses an ionizable dopant such as N₂, B, Ar, P or the like. The electric resistance of the heaters 123a can be regulated by type and amount of the dopant 128 used during the ion implantation process.

After regulating the electric resistance of the heaters 123a by the ion implantation process, the photo resist pattern 126 is removed by ashing and cleaning processes, and then the resultant substrate 121 is annealed at a temperature of more than 200° C. to increase uniformity of the dopant 128 in the heater 123a of the wire/heater pattern 123, as in the heater apparatus 100 of the first embodiment.

After annealing the resultant substrate 121, as shown in FIG. 5C, over a whole surface of the resultant substrate 121 are formed in turn the passivation layer 125 such as silicon nitride, silicon carbide and the like and the anti-cavitation layer 129 made of a metal layer such as Ta, TaN, TiN and the like. The fabrication of the heater apparatus 100″ is thus completed.

Embodiment 4

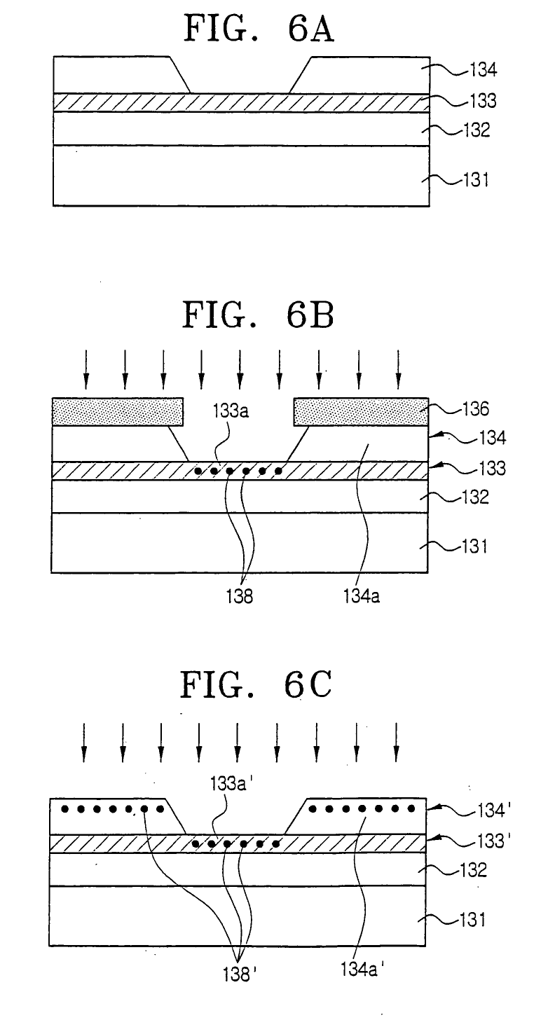

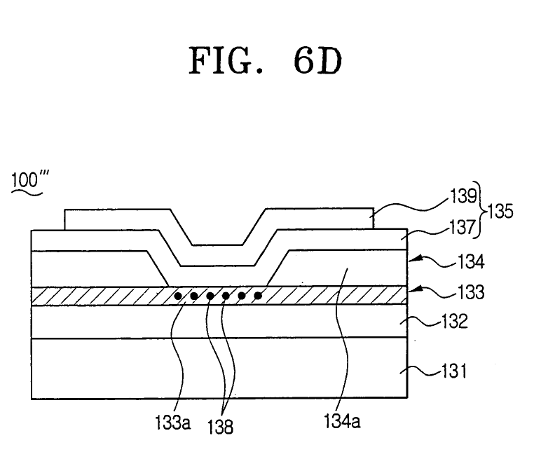

FIG. 6C shows a heater apparatus 100′″ of an ink-jet print head, having heaters 133a and wires 134a according to a fourth embodiment of the present invention.

The heater apparatus 100′″ of this embodiment includes a semiconductor substrate 131 such as a silicon substrate, a heater pattern 133 formed over the silicon substrate 131 and having a plurality of heaters 133a as resistance heat emitting bodies to heat ink, and a wire pattern 134 formed on the heater pattern 133 and having a plurality of wires 134a to connect switching elements (not shown) of a transistor. The heater apparatus 100′″ also includes a protective layer 135 formed on the heater pattern 133 and the wire pattern 134 to protect the heater pattern 133 and the wire pattern 134.

On the silicon substrate 131 is disposed an insulator layer 132 as an interlayer dielectric layer. The insulator layer 132 is formed of oxide on a whole surface of the silicon substrate 131.

The heater pattern 133 and the wire pattern 134 disposed on the insulator layer 132 is formed by vapor-depositing in turn a heater layer and a wire layer on the insulator layer 132 by a sputtering method or the like, and then patterning the wire layer and the heater layer by using a photo resist pattern (not shown) for wires and a photo resist pattern (not shown) for heaters respectively formed by a photolithography process. The heater layer is made of material for heaters such as Ta, poly-silicon or the like and the wire layer is made of a metal such as Al, Al-contained alloy or the like.

The heaters 133a formed in the heater pattern 133 have a dopant 138 doped therein by an ion implantation process after forming the heater pattern 133 and the wire pattern 134 over the substrate 131. The ion implantation process uses a photo resist pattern 136 to open heaters 133a to be formed later, formed over the substrate 131 through a photolithography process, as an ion implantation mask. Any type of ionizable dopant such as N₂, B, Ar, P or the like are used as a dopant, as shown in FIG. 6BA. The dopant 138 regulates an electric resistance of the heaters 133a at a required value.

During the ion implantation process for the heaters 133a, as the wire pattern 134 is masked by the photo resist pattern 136 formed through the photolithography process, the dopant 138 is not implanted in the wires 134a.

Alternatively, as shown in FIG. 6BB, the wire pattern 134′ can be formed to have a dopant 138′ doped therein by performing during an ion implantation process for heaters 133a′ without an ion implantation mask. In this case, a sum total in thickness of a heater pattern 133′ and a wire pattern 134′ is 500 Å. Particularly, the wire pattern 134′ is thick enough to assure the dopant 138′ doped during the ion implantation process does not affect an electric resistance of the wires 134a′ and the heater pattern 133′ is thin enough to assure the dopant 138′ doped during the ion implantation process to thereby regulate an electric resistance of the heaters 133a′.

The protective layer 135 includes a passivation layer 137 made of silicon nitride, silicon carbide and the like which can not only act as a passivation layer, but also act as a capping layer for the heater 133a or 133a′ and the wires 134a or 134a′. The protective layer 135 also includes an anti-cavitation layer 139 made of a metal layer such Ta, TaN, TiN or the like vapor-deposited on the passivation layer 137 to isolate ink.

A fabrication method of the heater apparatus 100′″ of the ink-jet print head as constructed according to the fourth embodiment of the present invention will be described in great detail with reference to FIGS. 6A through 6C.

First, a silicon substrate 131 is provided having the insulator layer 132 formed thereon.

Next, over a whole surface of the silicon substrate 131 having the insulator layer 132 formed thereon is vapor-deposited material for heaters such as Ta, poly-silicon and the like by a sputtering process or a LPVCD process. As a result, a heater layer (not shown) is formed.

Next, on the heater layer is vapor-deposited a wire layer (not shown) made of a metal, for example Al or Al-contained alloy, which has good conductivity to form wires and is able to be easily patterned, by a sputtering process.

After forming the wire layer, the wire layer and the heater layer are respectively patterned by using a photo resist pattern (not shown) for wires and a photo resist pattern (not shown) for heaters, respectively formed by photolithography processes, as etch masks, so that the wire pattern 134 and the heater pattern 133 are formed, as shown in FIG. 6A. At this point, each of the photolithography processes to form the photo resist pattern for wires and the photo resist pattern for heaters is carried out by forming a photo resist on the wire layer, and then exposing the photo resist to light by using a photo mask (not shown) for wires or a photo mask (not shown) for heaters and developing the exposed photo resist.

After that, a photo resist is formed over the substrate 131 having the wire pattern 134 and the heater pattern 133 formed thereover. Then, as shown in FIG. 6BA, the photo resist pattern 136 to open the heaters to be formed later is formed by performing a light exposure and a developing with respect to the photo resist through a photolithography process of using a photo mask for heaters.

Subsequently, an ion implantation process is carried out with respect to the heater pattern 133 by using the photo resist pattern 136 as an ion implantation mask, so that in the heater pattern 133, heaters 133a having a dopant 138 doped therein are formed. During the ion implantation process, the dopant 138 uses an ionizable dopant such as N₂, B, Ar, P or the like.

After forming the heaters 133a, the photo resist pattern 136 is removed by ashing and cleaning processes which are carried out at the same conditions as described with reference to the above embodiments.

Alternatively, as shown in FIG. 6BB, when a sum total in thickness of the heater pattern 133′ and the wire pattern 134′ is 500 Å, and the wire pattern 134′ is thick enough to assure a dopant 138′ doped during the ion implantation process does not affect an electric resistance of the wires 134a′ and the heater pattern 133′ is thin enough to assure the dopant 138′ doped during the ion implantation process to regulate an electric resistance of heaters 133a′, the ion implantation process can be carried out with respect to the heater pattern 133′ without using an ion implantation mask. Thus, both the heater pattern 133′ and the wire pattern 134′ are doped. At this point, the dopant 138′ is an ionizable dopant such as N₂, B, Ar, P or the like.

Thus, after doping the heater pattern 133 or 133′, the substrate 131 having the heaters 133a or 133a′ formed thereover is annealed at a temperature of more than 200° C. to increase uniformity of the dopant 138 or 138′ in the heater pattern 133 or 133′.

After annealing the substrate 131, as shown in FIG. 6C, over a whole surface of the resultant substrate 131 are formed in turn the passivation layer 137 such as a silicon nitride, silicon carbide or the like and the anti-cavitation layer 139 made of a metal layer such as Ta, TaN, TiN or the like. The fabrication of the heater apparatus 100′″ of the ink-jet print head is thus completed.

Embodiment 5

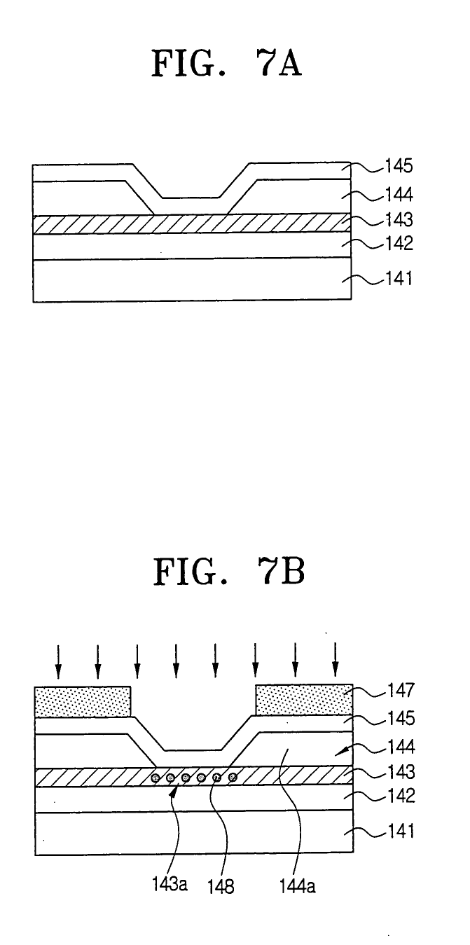

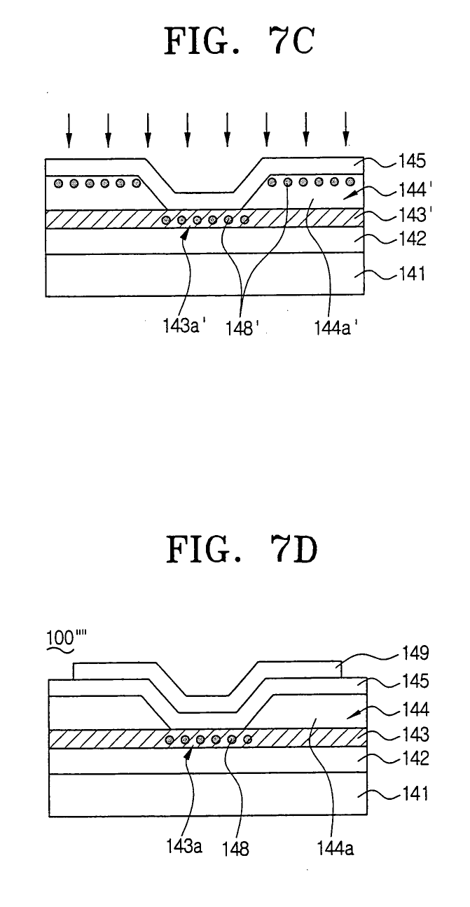

FIG. 7C shows a heater apparatus 100″″ of an ink-jet print head, having heaters 143a and wires 144a according to a fifth embodiment of the present invention.

The heater apparatus 100″″ of this embodiment includes a semiconductor substrate 141 such as a silicon substrate, a heater pattern 143 formed over the silicon substrate 141 and having a plurality of the heaters 143a as resistance heat emitting bodies to heat ink, a wire pattern 144 formed on the heater pattern 143 and having a plurality of the wires 144a to connect switching elements (not shown) of a transistor, and a protective layer 145 formed on the heater pattern 143 and the wire pattern 144 to protect the heater pattern 143 and the wire pattern 144.

On the silicon substrate 141 is disposed an insulator layer 142 as an interlayer dielectric layer. The insulator layer 142 is formed of oxide on a whole surface of the silicon substrate 141.

The heater pattern 143 and the wire pattern 144 disposed on the insulator layer 142 is formed by vapor-depositing in turn a heater layer made of material for heaters such as Ta, poly-silicon or the like and a wire layer made of a metal such as Al, Al-contained alloy or the like on the insulator layer 142 by a sputtering method or the like. Then, the wire layer and the heater layer are patterned by using a photo resist pattern (not shown) for wires and a photo resist pattern (not shown) for heaters respectively formed by photolithography processes as etch masks.

The heaters 143a formed in the heater pattern 143 have a dopant 148 doped therein by an ion implantation process after forming the protective layer 145 on the heater pattern 143 and the wire pattern 144. The ion implantation process uses a photo resist pattern 147 to open heaters (to be formed later), formed on the protective layer 145 through a photolithography process as an ion implantation mask, and any type of ionizable dopant including N₂, B, Ar, P or the like as a dopant, as shown in FIG. 7BA. The dopant 148 functions to regulate an electric resistance of the heaters 143a at a required value.

During the ion implantation process for the heaters 143a, as the wire pattern 144 is masked by the photo resist pattern 147 formed through the photolithography process, the dopant 148 is not implanted in the wires 144a.

Alternatively, as shown in FIG. 7BB, the wire pattern 144′ can be formed to have a dopant 148′ doped therein by performing without an ion implantation mask during an ion implantation process for the heaters 143a′. In this case, a sum total in thickness of the heater pattern 143′ and the wire pattern 144′ is 500 Å. Particularly, the wire pattern 144′ is thick enough to assure the dopant 148′ doped during the ion implantation process does not affect an electric resistance of the wires 144a′ and the heater pattern 143′ is thin enough to assure that the dopant 148′ doped during the ion implantation process to regulate an electric resistance of the heaters 143a′.

The protective layer 145 is silicon nitride, silicon carbide or the like, which can not only act as a passivation layer, but can also act as a capping layer for the heaters 143a or 143a′ and the wires 144a or 144a′.

On the protective layer 145 is disposed an anti-cavitation layer 149 made of a metal layer such Ta, TaN, TiN or the like, vapor-deposited to isolate ink.

A fabrication method of the heater apparatus 100″″ of the ink-jet print head as constructed according to the fifth embodiment of the present invention will be described in great detail with reference to FIGS. 7A through 7C.

First, there is a provided a silicon substrate 141 having an insulator layer 142 formed thereon.

Next, over a whole surface of the silicon substrate 141 having the insulator layer 142 formed thereon is vapor-deposited material for heaters such as Ta, poly-silicon or the like by a sputtering process or a LPVCD process. As a result, a heater layer (not shown) is formed.

And then, on the heater layer is vapor-deposited a wire layer (not shown) made of a metal, for example Al or Al-contained alloy, which has good conductivity to form wires and is able to be easily patterned, by a sputtering process.

After forming the wire layer, the wire layer and the heater layer are respectively patterned by using a photo resist pattern (not shown) for wires and a photo resist pattern (not shown) for heaters respectively formed by photolithography processes, as an etch mask, so that the wire pattern 144 and the heater pattern 143 are formed. At this point, each of the photolithography processes to form the photo resist pattern for wires and the photo resist pattern for heaters is carried out by forming a photo resist on the wire layer, and then exposing the photo resist to light by using a photo mask (not shown) for wires or a photo mask (not shown) for heaters and developing the exposed photo resist.

After that, as shown in FIG. 7A, over a whole surface of the silicon substrate 141 is formed the protective layer 145 made of silicon nitride, silicon carbide and the like which can not only act as a passivation layer, but can also act as a capping layer for the heaters 143a and wires 144a.

After forming the protective layer 145, a photo resist is formed on the protective layer 145, and then as shown in FIG. 7BA, a photo resist pattern 147 for opening heaters to be formed later is formed by performing a light exposure and a developing with respect to the photo resist through a photolithography process of using a photo mask for heaters.

Subsequently, an ion implantation process is carried out with respect to the heater pattern 143 by using the photo resist pattern 147 as an ion implantation mask, so that in the heater pattern 143, the heaters 143a having the dopant 148 doped therein are formed. During the ion implantation process, the dopant 148 uses an ionizable dopant such as N₂, B, Ar, P or the like.

After forming the heaters 143a, the photo resist pattern 147 is removed by ashing and cleaning processes which are carried out in the same conditions as described with reference to the above embodiments.

Alternatively, as shown in FIG. 7BB, when a sum total in thickness of a heater pattern 143′ and a wire pattern 144′ is 500 Å, and the wire pattern 144′ is thick enough to assure a dopant 148′ doped during the ion implantation process does not affect an electric resistance of wires 144a′, and the heater pattern 143′ is thin enough to assure the dopant 148′ doped during the ion implantation process to regulate an electric resistance of heaters 143a′, the ion implantation process can be carried out with respect to the heater pattern 143′ without using an ion implantation mask. Thus, both the heater pattern 143′ and the wire pattern 144′ are doped. At this point, the dopant 148′ is an ionizable dopant including N₂, B, Ar, P or the like.

Thus, after doping the heater pattern 143 or 143′, the substrate 141 having the heater 143a or 143a′ formed thereover is annealed at a temperature of more than 200° C. to increase uniformity of the dopant 148 or 148′ in the heater pattern 143 or 143′.

After annealing the substrate 141, as shown in FIG. 7C, on the protective layer 145 is formed an anti-cavitation layer 149 made of a metal layer such as Ta, TaN, TiN or the like, and the fabrication of the heater apparatus 100″″ of the ink-jet print head is finally complete.

Embodiment 6

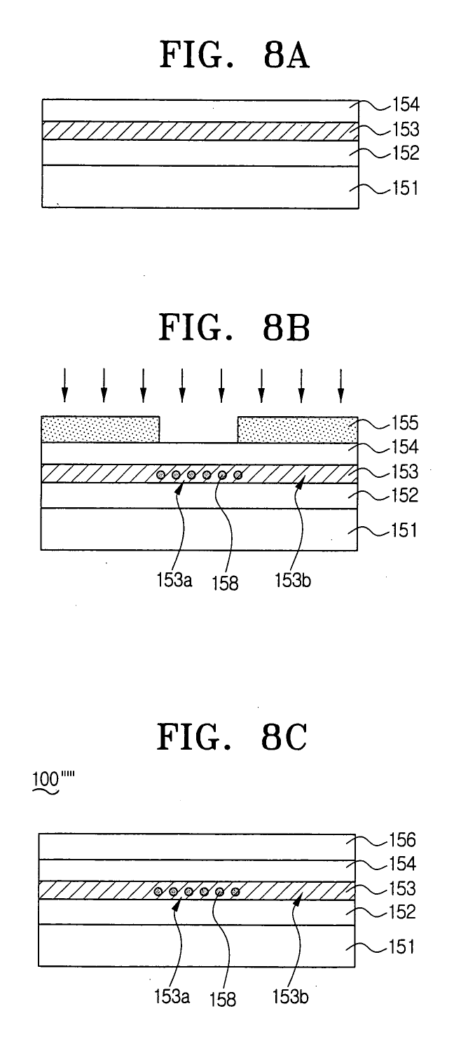

FIG. 8C shows a heater apparatus 100″″′ of an ink-jet print head, having heaters 153a and wires 153b according to a sixth embodiment of the present invention.

The heater apparatus 100″″′ of this embodiment includes a semiconductor substrate 151 such as a silicon substrate, and a wire/heater pattern 153 formed of one electric conductor layer over the silicon substrate 151 and having a plurality of the heaters 153a such as resistance heat emitting bodies to heat ink. The heater apparatus 100″″ also includes a plurality of wires 153b, and a protective layer 154 formed on the wire/heater pattern 153 to protect the wire/heater pattern 153.

On the silicon substrate 151 is disposed an insulator layer 152 as an interlayer dielectric layer. The insulator layer 152 is formed of oxide on a whole surface of the silicon substrate 151, as in the heater apparatus 100″″ of the fifth embodiment.

The wire/heater pattern 153 disposed on the insulator layer 152 is formed by vapor-depositing an electric conductor layer such as a metal wire layer made of Al or Al-contained alloy, on the insulator layer 152 by a sputtering method or the like. Then the electric conductor layer is sputtered by using a photo resist pattern (not shown) for wires/heaters formed by a photolithography process as an etch mask.

The heaters 153a formed in the wire/heater pattern 153 have a dopant 158 doped therein by an ion implantation process after forming the protective layer 154 on the wire/heater pattern 153. The ion implantation process uses a photo resist pattern 155 to open heaters which are formed later, formed on the protective layer 154 through a photolithography process, as an ion implantation mask. The ion implantation process also uses an ionizable dopant such as N₂, B, Ar, P or the like as a dopant 158. The dopant 158 implanted in the heaters 153a of the wire/heater pattern 153 during the ion implantation process regulates an electric resistance of the heaters 153a at a required value.

During the ion implantation process for the heaters 153a, as the wire/heater pattern 153 is masked by the photo resist pattern 155 formed through the photolithography process, the dopant 158 is not implanted in the wires 153b.

The protective layer 154 is silicon nitride, silicon carbide or the like which can not only act as a passivation layer, but can also act as a capping layer for the heater 153a and the wires 153b.

On the protective layer 155 is disposed an anti-cavitation layer 156 made of a metal layer such Ta, TaN, TiN or the like.

A fabrication method of the heater apparatus 100″″′ of the ink-jet print head as constructed according to the sixth embodiment of the present invention will be described in great detail with reference to FIGS. 8A through 8C.

First, there is provided the silicon substrate 151 having the insulator layer 152 formed thereon.

Next, over a whole surface of the silicon substrate 151 having the insulator layer 152 formed thereon is an electric conductor layer (not shown) such as a metal wire layer made of a metal, for example Al or Al-contained alloy, which has good conductivity to form wires and is able to be easily patterned, by a sputtering process.

Then, the electric conductor layer is patterned by using a photo resist pattern (not shown) for wires/heaters formed by a photolithography process as an etch mask, so that a wire/heater pattern 153 is formed. At this point, the photolithography process to form the photo resist pattern for wires/heaters is carried out by forming a photo resist on the electric conductor layer, and then exposing the photo resist to light by using a photo mask (not shown) for wires/heaters and developing the exposed photo resist.

Next, as shown in FIG. 8A, over a whole surface of the silicon substrate 151 having the wire/heater pattern 153 is formed the protective layer 145 made of silicon nitride, silicon carbide or the like, which can not only act as a passivation layer, but also act as a capping layer for the heaters 153a and the wires 153b.

After forming the protective layer 154, a photo resist (not shown) is formed on the protective layer 154, and as shown in FIG. 8B, the photo resist pattern 155 to open the heaters is formed by performing a light exposure and a developing with respect to the photo resist through a photolithography process using a photo mask for the heaters.

Subsequently, an ion implantation process is carried out with respect to the wire/heater pattern 153 by using the photo resist pattern 155 as an ion implantation mask, so that in the wire/heater pattern 153, the heaters 153a having the dopant 158 doped therein are formed. During the ion implantation process, the dopant 158 uses one of all kinds of ionizable dopants including N₂, B, Ar, P and the like.

After forming the heaters 153a, the photo resist pattern 155 is removed by ashing and cleaning processes which are carried out at the same conditions as described with reference to the above embodiments.

Thus, after removing the photo resist pattern 155, the substrate 151 having the heater 153a formed thereon is annealed at a temperature of more than 200° C. to increase uniformity of the dopant 158 in the wire/heater pattern 153.

After annealing the substrate 151, as shown in FIG. 8C, on the protective layer 154 is formed the anti-cavitation layer 156 made of a metal layer such as Ta, TaN, TiN or the like, and the fabrication of the heater apparatus 100″″′ of the ink-jet print head is complete.

As is apparent from the foregoing description, it can be appreciated that the heater apparatus of the ink-jet print head and the fabrication method thereof according to the embodiments of the present invention can easily fabricate wires and/or heaters having required values in electrical resistance and thickness, and enhance reliability of an electric conductor layer and/or a wire layer and a heater layer forming the wires and/or the heaters. These advantages are achieved by regulating the electric resistance of the wires and/or the heaters through the ion implantation process and/or the negative ion implantation process which is carried out separate from an electric conductor layer forming process, a wire layer and heater layer forming process, or a wire/heater layer forming process.

Further, the heater apparatus and the fabrication method thereof according to the embodiments of the present invention can increase uniformity of a dopant in wires and/or heaters, by performing a heat treatment process after the ion implantation process and/or the negative ion implantation process.

Still further, the heater apparatus and the fabrication method thereof according to the embodiments of the present invention can form a protective layer only on heaters to increase uniformity of electric resistance thereof, and reduce a number of fabrication processes, by forming the heaters with an electric conductor layer such as a wire layer without using a separate heater layer.

Also, the heater apparatus and the fabrication method thereof according to the embodiments of the present invention can prevent contamination of heaters and change in electrical resistance thereof caused by a photo resist used to form a photo resist pattern for heaters. This is achieved by performing an ion implantation process of using the photo resist pattern for heaters as an ion implantation mask to regulate the electric resistance of the heaters after forming a protective layer such as a passivation layer or a capping layer.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A heater apparatus of an ink-jet print head comprising:
a substrate;
a wire/resistance heat emitting body pattern on the substrate and including an electric conductor layer;
a plurality of wires in the wire/resistance heat emitting body pattern;
a plurality of resistance heat emitting bodies to heat ink in the wire/resistance heat emitting body pattern; and
a protective layer formed on the wire/resistance heat emitting body pattern to protect the wire/resistance heat emitting body pattern,
wherein the wires have a first dopant doped therein by an ion implantation process carried out to regulate an electric resistance of the wires after forming the wire/resistance heat emitting body pattern over the substrate.

2. The heater apparatus of claim 1, wherein the first dopant comprises an ionizable dopant.

3. The heater apparatus of claim 1, wherein the resistance heat emitting bodies include a second dopant doped therein by a negative ion implantation process carried out after the ion implantation process for the wires and the second dopant doped comprises an ionizable dopant.

4. A fabrication method of a heater apparatus of an inkjet print head comprising:
forming an electric conductor layer over a silicon substrate;
forming a wire/resistance heat emitting body pattern including a plurality of resistance heat emitting bodies and a plurality of wires by patterning the electric conductor layer;
forming a photo resist pattern to mask the resistance heat emitting bodies on the wire/resistance heat emitting body pattern;
regulating an electric resistance of the wires of the wire/resistance heat emitting body pattern comprising performing an ion implantation process using the photo resist pattern as a first ion implantation mask; and
removing the photo resist pattern.

5. The method of claim 4, wherein the performing of the ion implantation process comprises doping an ionizable dopant in the wires.

6. The method of claim 5, further comprising annealing the silicon substrate at a temperature of more than 200° C.

7. The method of claim 4, further comprising:
regulating an electric resistance of the resistance heat emitting bodies by performing a negative ion implantation process using the photo resist pattern as a second ion implantation mask, wherein the performing of the negative ion implantation process comprises:
doping an ionizable dopant in the resistance heat emitting bodies, and
controlling an ion implantation energy so that the dopant reaches the resistance heat emitting bodies disposed under the photo resist pattern.

8. A heater apparatus of an ink-jet print head comprising:
a substrate;
a wire/resistance heat emitting body pattern on the substrate and including an electric conductor layer;
a plurality of wires in the wire/resistance heat emitting body pattern;
a plurality of resistance heat emitting bodies to heat ink in the wire/resistance heat emitting body pattern; and
a protective layer formed on the wire/resistance heat emitting body pattern to protect the wire/resistance heat emitting body pattern,
wherein the resistance heat emitting bodies have a dopant doped therein by an ion implantation process carried out to regulate an electric resistance of the resistance heat emitting bodies after forming the wire/resistance heat emitting body pattern over the substrate.

9. The heater apparatus of claim 8, wherein the dopant comprises an ionizable dopants.

10. A fabrication method of a heater apparatus of an ink-jet print head comprising:
forming an electric conductor layer over a silicon substrate;
forming a wire/resistance heat emitting body pattern including a plurality of resistance heat emitting bodies and a plurality of wires by patterning the electric conductor layer;
forming a photo resist pattern to open the resistance heat emitting bodies on the wire/resistance heat emitting body pattern;
regulating an electric resistance of the resistance heat emitting bodies of the wire/resistance heat emitting body pattern comprising performing an ion implantation process using the photo resist pattern as an ion implantation mask; and
removing the photo resist pattern.

11. The method of claim 10, wherein the performing of the ion implantation process comprises doping of an ionizable dopant in the resistance heat emitting bodies.

12. The method of claim 11, further comprising annealing the silicon substrate at a temperature of more than 200° C.

13. A heater apparatus of an ink-jet print head comprising:
a substrate;
a resistance heat emitting body pattern formed over the substrate and including a plurality of resistance heat emitting bodies to heat ink;
a wire pattern formed on the resistance heat emitting body pattern and having a plurality of wires; and
a protective layer formed on the resistance heat emitting body pattern and the wire pattern to protect the resistance heat emitting body pattern and the wire pattern,
wherein the resistance heat emitting bodies have a dopant doped therein by an ion implantation process carried out to regulate an electric resistance of the resistance heat emitting bodies after forming the resistance heat emitting body pattern and the wire pattern over the substrate.

14. The heater apparatus of claim 13, wherein the wires do not have the dopant doped therein during the ion implantation process and the dopant is an ionizable dopant.

15. The heater apparatus of claim 13, wherein the wires have the dopant doped therein during the ion implantation process for the resistance heat emitting bodies, a total thickness of the resistance heat emitting body pattern and the wire pattern is 500 Å, the wire pattern is thick enough so that the dopant does not affect an electric resistance of the wires and the heat emitting body pattern is thin enough so that the dopant regulates an electric resistance of the resistance heat emitting bodies and the dopant is an ionizable dopant.

16. A fabrication method of a heater apparatus of an ink-jet print head comprising:
forming a resistance heat emitting body layer over a silicon substrate;
forming a wire layer on the resistance heat emitting body layer;
forming a wire pattern by patterning the wire layer;
forming a resistance heat emitting body pattern by patterning the resistance heat emitting body layer; and
doping the resistance heat emitting body pattern including a plurality of heat emitting bodies over the silicon substrate over which the resistance heat emitting body pattern and the wire pattern are formed.

17. The method of claim 16, wherein the doping comprises:
forming a photo resist over the silicon substrate over which the wire pattern and the resistance heat emitting body pattern are formed;
forming a photo resist pattern for opening the resistance heat emitting bodies by exposing the photo resist to light and developing the exposed photo resist through a photolithography process;
performing an ion implantation process by using the photo resist pattern as an ion implantation mask and doping an ionizable dopant into the resistance heat emitting body pattern; and
removing the photo resist pattern.

18. The method of claim 16, wherein the doping comprises:
performing an ion implantation process without using an ion implantation mask to allow an ionizable dopant to be doped into the wire pattern.

19. The method of claim 16, further comprising annealing the silicon substrate at a temperature of more than.

20. A heater apparatus of an ink-jet print head comprising:
a substrate;
a resistance heat emitting body pattern formed over the substrate and including a plurality of resistance heat emitting bodies to heat ink;
a plurality of switching elements;
a wire pattern formed on the resistance heat emitting body pattern and including a plurality of wires connecting the switching elements; and
a protective layer formed on the resistance heat emitting body pattern and the wire pattern to protect the resistance heat emitting body pattern and the wire pattern, wherein the resistance heat emitting bodies have a dopant doped therein by an ion implantation process carried out to regulate an electric resistance of the resistance heat emitting bodies after forming the protective layer on the resistance heat emitting body pattern and the wire pattern.

21. The heater apparatus of claim 20, wherein the wires do not have the dopant doped therein by using a photo resist pattern formed through a photolithography process as an ion implantation mask to mask the wires during the ion implantation process for the resistance heat emitting bodies.

22. The heater apparatus of claim 21, wherein the dopant is an ionizable dopant.

23. The heater apparatus of claim 20, wherein the dopant is doped in the wires during the ion implantation process.

24. The heater apparatus of claim 23, wherein a total thickness of the resistance heat emitting body pattern and the wire pattern is 500 Å, the wire pattern is thick enough so that the dopant doped during the ion implantation process does not affect an electric resistance of the wires and the resistance heat emitting body pattern is thin enough so that the dopant doped during the ion implantation process regulates the electric resistance of the resistance heat emitting bodies.

25. The heater apparatus of claim 24, wherein the dopant is an ionizable dopant.

26. A heater apparatus of an ink-jet print head comprising:
a substrate;
a plurality of switching elements;
a wire/resistance heat emitting body pattern formed of an electric conductor layer over the substrate and having a plurality of resistance heat emitting bodies to heat ink and a plurality of wires connecting the switching elements;
and a protective layer formed on the wire/resistance heat emitting body pattern to protect the wire/resistance heat emitting body pattern,
wherein the resistance heat emitting bodies have a dopant doped therein by an ion implantation process carried out by using a photo resist pattern formed through a photolithography process as an ion implantation mask to regulate an electric resistance of the resistance heat emitting bodies.

27. The heater apparatus of claim 26, wherein the wires do not have the dopant doped therein by being masked through the photo resist pattern used as the ion implantation mask during the ion implantation process for the resistance heat emitting bodies.

28. The heater apparatus of claim 26, wherein the dopant is an ionizable dopant.

29. A fabrication method of a heater apparatus of an ink-jet print head comprising:
forming a resistance heat emitting body layer including a plurality of resistance heat emitting bodies over a silicon substrate;
forming a wire layer on the resistance heat emitting body layer;
forming a wire pattern by patterning the wire layer;
forming a resistance heat emitting body pattern by patterning the resistance heat emitting body layer;
forming a protective layer over a whole surface of the silicon substrate over which the resistance heat emitting body pattern is formed; and
doping the resistance heat emitting body pattern over the silicon substrate.

30. The method of claim 29, wherein the doping comprises:
forming a photo resist on the protective layer;
forming a photo resist pattern to open the resistance heat emitting bodies by exposing the photo resist to light and then developing the exposed photo resist through a photolithography process;
performing an ion implantation process by using the photo resist pattern as an ion implantation mask; and
removing the photo resist pattern.

31. The method of claim 30, wherein the performing of the ion implantation process comprises using an ionizable dopant.

32. The method of claim 30, wherein the removing of the photo resist pattern comprises ashing and cleaning.

33. The method of claim 29, wherein the doping of the resistance heat emitting body pattern comprises performing an ion implantation process without using an ion implantation mask to allow a dopant to be doped into the wire pattern.

34. The method of claim 33, wherein the ion implantation process comprises using an ionizable dopant.

35. The method of claim 29, further comprising annealing the silicon substrate at a temperature of more than 200° C., after the doping of the resistance heat emitting body pattern.

36. A fabrication method of a heater apparatus of an ink-jet print head comprising:
forming an electric conductor layer over a silicon substrate;
forming a wire/resistance heat emitting body pattern including a plurality of wire/resistance heat emitting bodies by patterning the electric conductor layer;
forming a protective layer over the silicon substrate over which the wire/resistance heat emitting body pattern is formed;
forming a photo resist pattern to open the wire/resistance heat emitting bodies on the protective layer;
forming the wire/resistance heat emitting bodies in the wire/resistance heat emitting body pattern comprising performing an ion implantation process using the photo resist pattern as an ion implantation mask; and
removing the photo resist pattern.

37. The method of claim 36, wherein the forming of the photo resist pattern comprises:
forming a photo resist on the protective layer; and
exposing the photo resist to light and developing the exposed photo resist through a photolithography process using a photolithography mask including a pattern of the wire/resistance heat emitting bodies.

38. The method of claim 36, wherein the ion implantation process comprises using an ionizable dopant.

39. The method of claim 36, wherein the removing of the photo resist pattern comprises ashing and cleaning.

40. The method of claim 36, further comprising annealing the silicon substrate at a temperature of more than 200° C.
